(19) United States
(12) Patent Application Publication
(10) Pub. No.: US 2008/0268218 A1
(43) Pub. Date: Oct. 30, 2008

(54) INSULATED ELECTRIC WIRE

(76) Inventor: Joon-Hee Lee, Gyeonggi-do (KR)

Correspondence Address: JONES DAY, 222 EAST 41ST ST, NEW YORK, NY, 10017, US

(21) Appl. No.: 11/942,115

(22) Filed: Nov. 19, 2007

(30) Foreign Application Priority Data
Apr. 27, 2007 (KR) 10-2007-0041408

(51) Int. Cl. B32B 7/02; B32B 27/06

(52) U.S. Cl. 428/213; 428/375

(57) ABSTRACT

The present invention relates to an insulated electric wire. The insulated electric wire according to the present invention includes a high adhesion resin layer made of a polyamideimide resin containing a compound having a polar group in a molecular structure of an insulation material; and a high flexibility resin layer provided on the high adhesion resin layer. The present invention advantageously improves adherence between a polyamideimide resin and a conductor, and provides adhesive strength with the conductor to improve flexibility of the insulated electric wire and at the same time to improve flexibility of an insulator without deterioration of heat resistance of the insulator.

### BACKGROUND OF THE INVENTION

1. Field of the Invention

The present invention relates to an insulated electric wire, and in particular to an insulated electric wire which improves adherence between a polyamideimide resin and a conductor, and provides adhesive strength with the conductor to improve its flexibility and at the same time to improve flexibility of an insulator without deterioration of heat resistance of the insulator.

2. Description of the Related Art

Recently, with a trend toward reduced size and weight of electrical or electronic devices, it has been required for a motor having high performance, small size and light weight. To meet such a requirement, it is necessary to increase the winding number of insulated electric wire on a core of a motor. Therefore, to further wind the insulated electric wire on a small space, there has been a rise in the demand for a motor having a collapsible core using a concentrated winding method rather than a distributed winding method.

For this purpose, more amount of insulated electric wire should be forced into a core slot, and in this case, a strong pulling force occurs, and as a result, an insulation coating of the insulated electric wire may be damaged while being wound on a core. If the insulation coating is damaged, stack or earth is not made, and thus it tends to deteriorate an electrical characteristic of the motor.

A motor that has been used so far, typically uses an insulated electric wire having an insulation coating formed by coating and baking a coating paint of polyamideimide having good mechanical strength on a conductor, or an insulated electric wire having an existing insulation coating formed on a conductor. Generally, the polyamideimide uses a reaction product of diphenyl methane-4,4′-diisocyanate and a trimellitic anhydride.

In these days, it requires for a motor having higher performance, smaller size and lighter weight. To meet such a requirement, it is necessary to still further increase the winding number of insulated electric wire, and consequently, even a polyamideimide based insulation coating is damaged in some instances.

Therefore, to reduce damage of the insulation coating, there have been studies about providing lubrication to the insulation coating, for example a method for adding an organic or inorganic lubricant to the coating paint, or a method for directly applying a lubricant such as a wax on the insulated electric wire. However, these methods reduce damage of the insulation coating to some extent, but do not completely prevent damage of the insulation coating.

As another method, damage of the insulation coating may be reduced by increasing a mechanical strength of the insulation coating. However, a simple increase of mechanical strength results in more rigid and less flexible coating, and thus when producing a motor having a large curve using a concentrated winding method, the coating may be easily broken or peeled off, or a winding characteristic of the insulated electric wire may be weakened.

If modulus of elasticity and strength of polyamideimide having a rigid molecular structure increase, strength of the insulation coating itself increases, but the insulated electric wire becomes rigid, and thus when the insulated electric wire is bent, the insulation coating may be easily broken and peeled off from the conductor. This is because polyamideimide is easily broken and its adherence with the conductor reduces when polyamideimide becomes rigid.

To solve the problem, studies have been made to improve adherence between a polyamideimide resin and a conductor, for example JP Laid-open Patent Publication No. 3-37282 discloses a heat resistant paint containing a polyalkoxy modified resin and bezotriazole in a polyamideimide resin solution, JP Laid-open Patent Publication No. 6-111632 discloses addition of trialkyamine to a polyamideimide resin solution, and JP Laid-open Patent Publication No. 10-334735 discloses addition of a melamine resin to a polyamideimide resin solution.

However, actually theses resins have poor solubility and compatibility, and in some instances, react with an unreacted terminal of a polyamideimide resin to deteriorate hypotonicity of the polyamideimide resin solution, and an increase of adhesion is not large. And, this type insulated electric wire can be applied to a motor which is inserted into a slot using a distributed winding method, but in the case that this insulated electric wire is applied to a motor having a collapsible core using a concentrated winding method, a coating is inevitably damaged when winding.

And, in the case that the insulated electric wire is damaged due to the increased adherence between the insulation coating and the conductor, a method for minimizing a leakage current has been suggested, but the suggested method did not completely solve the problem.

Further, recently there is a tendency to increase a diameter of an insulated electric wire to apply high capacity current and increase the output of a motor, and when the insulated electric wire of large diameter is wound on a narrow core under a concentrated load, very large load is concentrated on a coating of the insulated electric wire, and in this case, the coating may split more frequently.

Meanwhile, an insulated electric wire of polyamideimide resin has good characteristic in the whole, but has poor adherence with a conductor as crystalline, and thus in the case that the insulated electric wire of polyamideimide resin becomes thicker, its flexibility may reduce. If the adherence with the conductor is improved, flexibility and workability of the insulated electric wire of polyamideimide resin may be improved, however the polyamideimide coating having strong adhesive property has proper adherence, but poor strength, which is insufficient for an outmost coating.

And, if flexibility of the insulated electric wire is increased, heat resistance of the insulated electric wire is disadvantageously reduced, which is pointed out to be a difficult matter.

Therefore, there have been attempts in the related industry to solve the above-mentioned problems of the prior arts, and the present invention is devised under such a technical background.

The present invention is designed to solve the above-mentioned problems of the prior arts, and therefore it is an object of the present invention to provide an insulated electric wire which solves the conventional problems of a polyamideimide resin including reduction of adherence with a conductor and reduction of flexibility, and solves the disadvantage that heat resistance is reduced when flexibility is increased.

### SUMMARY OF THE INVENTION

In order to achieve the above-mentioned objects, the present invention provides an insulated electric wire including a high adhesion resin layer configured to surround an outer surface of a conductor and made of a polyamideimide resin containing a compound represented as the following Chemistry Figure 1 between imide groups in a polymer main chain; and a high flexibility resin layer provided on the high adhesion resin layer, manufactured by reacting an aromatic diisocyanate compound, an acid anhydride and a polybasic acid component and made of a polyamideimide resin containing more content of the polybasic acid component than the acid anhydride,

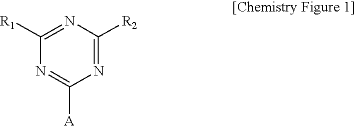

where each of R₁ and R₂ is independently any one of an imide group and an imide group-alkylene group, and at this time, the alkylene group is any one selected from methylene and ethylene, A is any one selected from

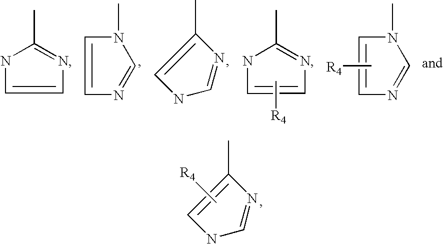

and at this time, R₄ represented in Chemistry Figure of a material selected as A is independently any one alkyl group selected from methyl and ethyl.

In order to achieve the above-mentioned objects, the present invention also provides an insulated electric wire including a high adhesion resin layer configured to surround an outer surface of a conductor and made of a polyamideimide resin containing a compound represented as the following Chemistry Figure 2 between imide groups in a polymer main chain; and a high flexibility resin layer provided on the high adhesion resin layer, manufactured by reacting an aromatic diisocyanate compound, an acid anhydride and a polybasic acid component and made of a polyamideimide resin containing more content of the polybasic acid component than the acid anhydride,

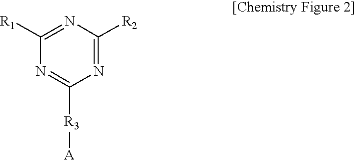

where each of R₁ and R₂ is independently any one of an imide group and an imide group-alkylene group, and at this time, the alkylene group is any one selected from methylene and ethylene, R₃ is any one alkylene group selected from methylene, ethylene and propylene, A is any one selected from

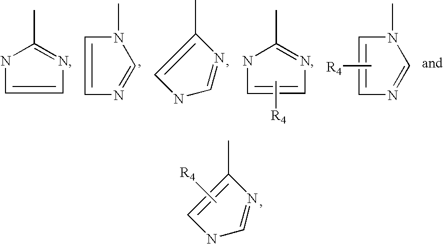

and at this time, R₄ represented in Chemistry Figure of a material selected as A is independently any one alkyl group selected from methyl and ethyl.

In the above Chemistry Figure 1 or 2, R₄ may be in the form of two R₄ bonded to an imidazole group.

Preferably, the compound of the above Chemistry Figure 1 or 2 is contained with a mole ratio of 1:1 to 1:0.1 to mole of an imide chain of the polyamideimide resin of the high adhesion resin layer.

The insulated electric wire may further include a self-lubricating polyamideimide resin layer provided on the high flexibility resin layer.

### BRIEF DESCRIPTION OF THE DRAWINGS

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

FIG. 1 is a view of an insulated electric wire surrounding an outer surface of a conductor according to an embodiment of the present invention.

### DESCRIPTION OF THE PREFERRED EMBODIMENT

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

To improve adherence between a polyamideimide resin and a conductor and flexibility of an insulated electric wire, the present invention contains a monomer having a polar group that provides adhesion with the conductor, and to improve compatibility with the polyamideimide resin, the present invention uses a polyamideimide resin containing the polar group at a molecular main chain to increase bondability with the conductor. And, the present invention coats a polyamideimide resin having excellent flexibility on the above-mentioned polyamideimide resin layer to provide an insulated electric wire having flexibility and improved adherence with the conductor.

The insulated electric wire of the present invention includes a high adhesion resin layer formed to surround an outer surface of the conductor and a high flexibility resin layer formed on the high adhesion resin layer.

Hereinafter, the insulated electric wire of the present invention is described in detail as follows.

a) High Adhesion Resin Layer

The high adhesion resin layer of the insulated electric wire is made of a polyamideimide resin containing a compound represented as the above Chemistry 1 or 2 between imide groups in a chain.

The polyamideimide resin that makes up the high adhesion resin layer is manufactured by addition-polymerizing diamines and an acid anhydride to manufacture an imidized acid and reacting the imidized acid with a diisocyanate compound.

The diamines may use triazines, specifically 2,4-diamino-6-[2-(2-methyl-1-imidazolyl)ethyl]-s-triazine, 2,4-diamino-6-[2-(2-ethyl-1-imidazolyl)ethyl]-s-triazine, 2,4-diamino-6-[1-(2-undecyl-1-imidazolyl)ethyl]-s-triazine, 2,4-diamino-6-[2-(2-imidazolyl)ethyl]-s-triazine, 2,4-diamino-6-[2-(1-(1-imidazolyl)ethyl)-s-triazine, 2,4-diamino-6-(2-ethyl-4-imidazolyl)-2-triazine, 2,4-diamino-6-[2-(4-methyl-1-imidazolyl)ethyl]-s-triazine, 2,4-diamino-6-(2-ethyl-5-methyl-4-imidazolyl)-s-triazine, 2,4-diamino-6-(4-ethyl-2-methyl-1-imidazolyl)-s-triazine, 2,4-diamino-6-[3-(2-methyl-1-imidazolyl)propyl]-s-triazine, 2,4-diamino-6-[4-(2-imidazolyl)butyl]-s-triazine, 2,4-diamino-6-[2-methyl-1-imidazolyl]propyl]-s-triazine, 2,4-diamino-6-[1-methyl-2-(2-methyl-1-imidazolyl)ethyl]-s-triazine, 2,4-diamino-6-[2-(2,5-dimethyl-1-imidazolyl)ethyl]-s-triazine, 2,4-diamino-6-[2-(2,4-dimethyl-1-imidazolyl)ethyl]-s-triazine or 2,4-diamino-6-[2-ethyl-4-methyl-1-imidazolyl]ethyl]-s-triazine, and in particular, it is preferable to use 2,4-diamino-6-[2-(2-methyl-1-imidazolyl)ethyl]-s-triazine (MZA).

The acid anhydride may use a conventional acid anhydride of a polyamic acid, for examples an aromatic anhydride including trimellitic anhydride (hereinafter referred to as TMA), pyromellitic anhydride (PMDA), 3,4,3,4′-biphenyltetracarboxylic anhydride (BPDA), 3,4,3′,4′-benzophenonetetracarboxylic anhydride (BTDA) or 3,4,3′,4′-diphenylsufonetetracarboxylic anhydride (DSDA).

The diamines and the acid anhydride are addition-polymerized with a ratio of 1:1 to 1:2 to obtain the imidized acid.

The diisocyanate compound reacted with the imidized acid, may use diphenyl methane-3,4′-diisocyanate, diphenyl methane-3,3′-diisocyanate, diphenyl methane-4,4′-diisocyanate (MDI), diphenyl ether-3,4′-diisocyanate, diphenyl ether-3,3′-diisocyanate, 2,3′-toluene diisocyanate, 2,4′-toluene diisocyanate, hexamethylene diisocyanate or chrysene diisocyanate.

At this time, it is preferable to react the imidized acid and the diisocyanate compound with an equivalence ratio of 0.8:1 to 1:0.8.

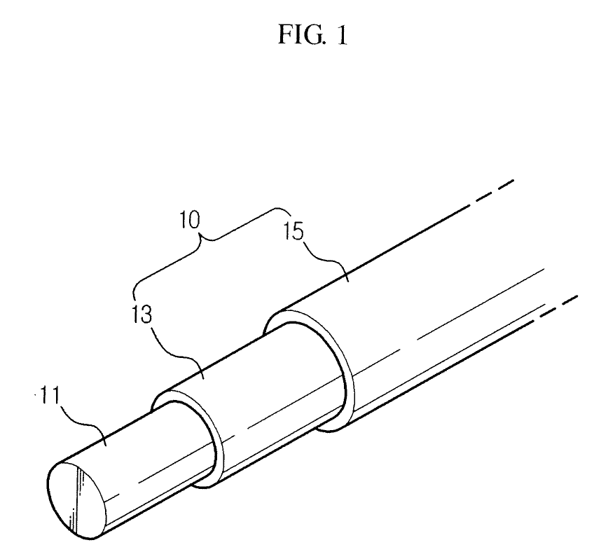

A method for manufacturing the polyamideimide resin containing the compound represented as the above Chemistry Figure 1 or 2 between the imide groups is described with reference to the following Reaction Equation 1. The following Reaction Equation 1 is just an embodiment for manufacturing the polyamideimide containing the compound represented as the above Chemistry 1 or 2 of the present invention between the imide groups, and manufacture of the polyamideimide resin containing the compound represented as the Chemistry Figure 1 or 2 between the imide groups is not limited to the following Reaction Equation 1.

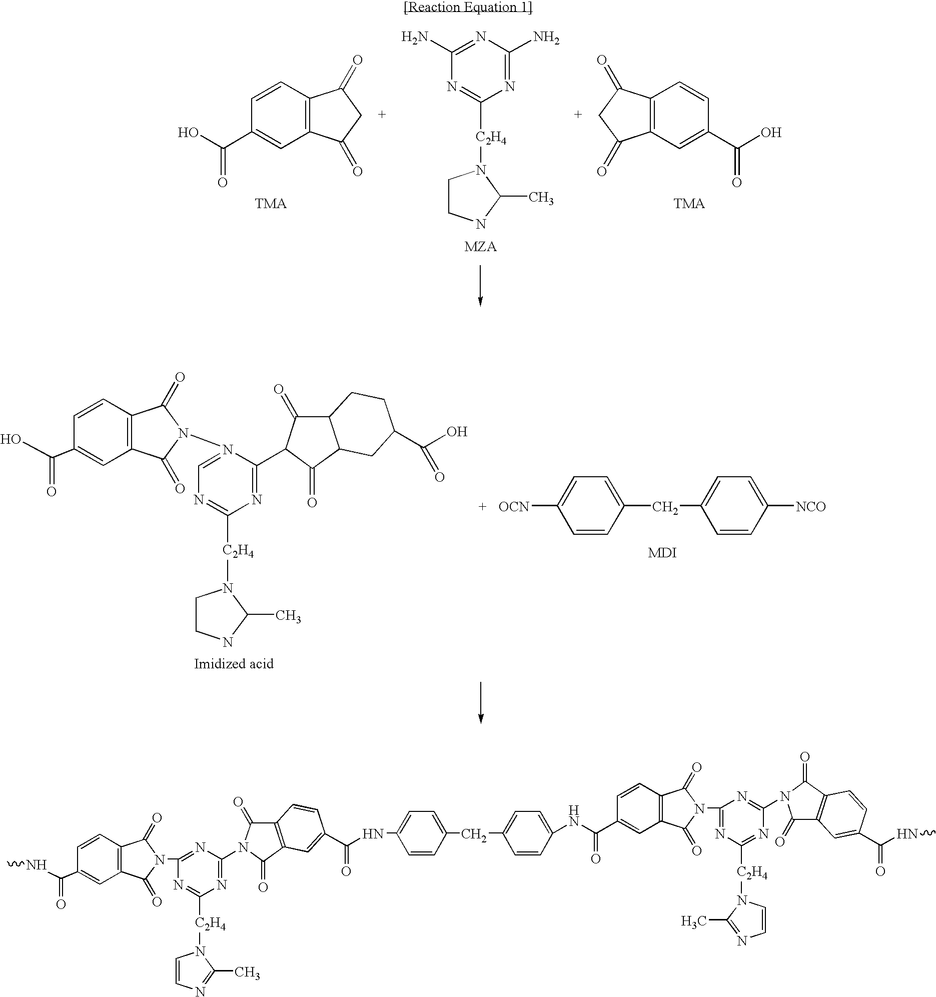

As shown in the above Reaction Equation 1,2,4-diamino-6-[2′-methylimidazolyl(1′)]-ethyl-s-triazine (MZA) is reacted with 2 mol of trimellitic anhydride (TMA) to manufacture an imidized acid, and the imidized acid is reacted with diphenylmethane-4,4′-diisocyanate (MDI) to manufacture a polyamideimide (PAI) resin. The polyamideimide resin contains a polar polymer to help improve adherence with a conductor.

Generally, in the case of an insulated electric wire using the polyamideimide resin, as wear resistance increases, flexibility and adherence decrease, however the present invention contains the compound represented as the above Chemistry Figure 1 or 2 between the imide groups of the polyamideimide resin to improve flexibility and adhesion of the insulated electric wire with a copper coil as well as wear resistance of the insulated electric wire.

b) High Flexibility Resin Layer

The high flexibility resin layer formed on the high adhesion resin layer made of the above-mentioned polyamideimide resin is made of a polyamideimide resin manufactured by reacting an aromatic diisocyanate compound, an acid anhydride, and a polybasic acid component.

That is, the polybasic acid component is used additionally to the diisocyanate compound and the acid anhydride that are used in manufacturing a general polyamideimide, to increase the content of amide in the polyamideimide resin, thereby improving flexibility of the insulated electric wire.

Preferably, the polybasic acid component has a polybasic acid functional group at meta or ortho position of an aromatic ring. When manufacturing a polyamideimide using the polybasic acid component, as a portion stiffened by a hydrogen bond within a polymer chain is softened by such a monomer, flexibility of a coating may be improved.

The polybasic acid component may use isophthalic acid, orthophthalic acid, benzophenone, dicarboxylic acid, 3,4′-diphenylmethanedicarboxylic acid, 3,3′-diphenylmethanedicarboxylic acid, 3,4′-diphenyletherdicarboxylic acid, 3,3′-diphenyletherdicarboxylic acid, 3,4′-diphenylsulfonedicarboxylic acid, 3,3′-diphenylsulfonedicarboxylic acid, adipic acid, sebacic acid or dodecane dicarboxylic acid.

Preferably, the polybasic acid component is contained with the content of 5 to 80 mol % of the entire polybasic or polybasic anhydride. In the case that the content is less than the minimum, it is not preferable because flexibility of an insulation coating does not increase, and in the case that the content is more than the maximum, the insulation coating is too much softened to reduce a mechanical property, thereby failing to serve as an insulation coating.

The aromatic diisocyanate compound, the acid anhydride, and the polybasic acid component may be polymerized in a proper organic solution with a substantially stoichiometric amount by the same method as a method for manufacturing a general polyamideimide. For example, the aromatic diisocyanate compound, the acid anhydride, and the polybasic acid component may be reacted in an organic solution with mole ratios of 0.3 to 1.0 mol of the acid anhydride and 0.05 to 0.08 mol of the polybasic acid component (preferably 0.2 to 0.5 mol) based on 1 mol of the diisocyanate compound between room temperature and 180° C. for 1 to 24 hours.

The insulated electric wire including the high adhesion resin layer and the high flexibility resin layer formed on the high adhesion resin layer according to the present invention may further include a typical self-lubricating resin layer which is formed on the high flexibility resin layer. At this time, preferably the high adhesion resin layer, the high flexibility resin layer and the self-lubricating resin layer has a thickness ratio of 1 to 9:9 to 1:1.

Hereinafter, the insulated electric wire according to an embodiment of the present invention is described with reference to FIG. 1.

FIG. 1 is a view of the insulated electric wire according to an embodiment of the present invention. As shown in FIG. 1, the insulated electric wire 10 according to an embodiment of the present invention includes a high adhesion resin layer 13 formed to surround an outer surface of a conductor 11 and arranged in contact with the outer surface of the conductor 11 while centering the conductor 11, and a high flexibility resin layer 15 formed on the high adhesion resin layer 13.

The high adhesion resin layer 13 and the high flexibility resin layer 15 are construed as described above.

Hereinafter, to help a better understanding, the present invention is described through preferred examples and comparative examples in more detail.

### Synthesis Example 1

### Manufacture of a High Adhesion Polyamideimide Varnish

675 parts by weight of N-methylpyrrolidone and 109.65 parts by weight of 2,4-diamino-6-[2-(2-methyl-1-imidazolyl)ethyl]-s-triazine was inputted and agitated in a 4-neck flask provided with an agitator and a condenser that were dried properly at room temperature. Moreover, 192.12 parts by weight of trimellitic anhydride (TMA) was inputted and reacted while increasing temperature up to 260° C. throughout 8 hours, and 18 parts by weight of water was discharged as a product, thereby manufacturing an acid having an imide group. Next, the acid having the imide group was cooled at room temperature again, and after diphenyl methane-4,4′-diisocyanate (MDI) was inputted, heated at 80° C. for 3 hours, and while increasing temperature up to 140° C. throughout 3 hours, heated at 140° C. for 3 hours, thereby obtaining a polyamideimide resin solution. Moreover, sorbetnaphtha, xylene and otherwise were added to obtain a high adhesion polyamideimide varnish containing 20% of solids.

### Synthesis Example 2

### Manufacture of a High Flexibility Polyamideimide Varnish

800 parts by weight of N-methylpyrrolidone, 250 parts by weight of diphenyl methane-4,4′-diisocyanate (MDI), 176.75 parts by weight of trimellitic anhydride (TMA) and 16.61 parts by weight of isophthalic acid (IPA) were inputted and agitated in a 4-neck flask provided with an agitator and a condenser that were dried properly at room temperature, and reacted while increasing temperature up to 160° C. throughout 8 hours, and carbon dioxide was discharged as a product, thereby obtaining a high flexibility polyamideimide resin solution. Moreover, sorbetnaphtha, xylene and otherwise were added to obtain a high flexibility polyamideimide varnish containing 25% of solids.

### Synthesis Examples 2-2 to 2-6

### Manufacture of a High Flexibility Polyamideimide Varnish Containing a Compound Represented as Chemistry Figure 1 or Chemistry Figure 2

The manufacture was made by the same method as the synthesis example 2-1, except for using of a composition ratio represented as the following Table 1.

The unit of the following table 1 is part by weight.

TABLE 1

| | Synthesis | Synthesis | Synthesis | Synthesis | Synthesis | Synthesis |
|---|---|---|---|---|---|---|
| Classification | Example 2-1 | Example 2-2 | Example 2-3 | Example 2-4 | Example 2-5 | Example 2-6 |
| Diphenyl | 250.00 | 250.00 | 250.00 | 250.00 | 250.00 | 250.00 |
| methane-4,4′- | | | | | | |
| diisocyanate | | | | | | |
| Isophthalic acid | 176.75 | 157.54 | 138.33 | 119.11 | 99.90 | 61.48 |
| Trimellitic | 16.61 | 33.23 | 49.84 | 66.45 | 83.07 | 116.29 |
| anhydride | | | | | | |

### Synthesis Example 3

### Manufacture of a Self-Lubricating Polyamideimide Varnish

800 parts by weight of N-methylpyrrolidone, 250 parts by weight of diphenyl methane-4,4′-diisocyanate (MDI) and 211 parts by weight of trimellitic anhydride (TMA) were inputted and agitated in a 4-neck flask provided with an agitator and a condenser that were dried properly at room temperature, and reacted while increasing temperature up to 160° C. throughout 8 hours, and carbon dioxide was discharged as a product, thereby obtaining an acid or acid anhydride-terminated polyamideimide resin solution.

Thereafter, 656 parts by weight of desmodur-L of Bayer in Germany and 2072 parts by weight of an OH-terminated silicone resin (1036 molecular weight, 1.6 weight % of OH) were inputted into a separate 4-neck flask provided with an agitator and a condenser that were dried properly at room temperature, and reacted at room temperature for 6 hours, thereby obtaining silicone and isocyanate-terminated multifunctional silicone derivatives.

Next, 4.5 parts by weight of the multifunctional silicone derivatives were inputted into the 100 parts by weight of the obtained polyamideimide resin solution, and reacted at 100° C. throughout 3 hours, thereby obtaining a self-lubricating polyamideimide varnish.

### Synthesis Example 4

### Manufacture of a General Polyamideimide Varnish

800 parts by weight of N-methylpyrrolidone, 250 parts by weight of diphenyl methane-4,4′-diisocyanate (MDI) and 210 parts by weight of trimellitic anhydride (TMA) were inputted and agitated in a 4-neck flask provided with an agitator and a condenser that are dried properly at room temperature, and reacted while increasing temperature up to 160° C. throughout 8 hours, and carbon dioxide was discharged as a product, thereby obtaining a high heat resistance polyamideimide resin solution. Moreover, sorbetnaphtha, xylene and otherwise were added to obtain a polyamideimide varnish containing 25% of solids.

### Examples 1 to 9 and Comparative Examples 1 to 2

### Manufacture of an Insulated Electric Wire

An insulated electric wire was manufactured using the polyamideimide varnish manufactured in the above synthesis examples by a coating plant of SICME in Italy according to the following Table 2.

At this time, note that the insulated electric wire was manufactured with 0.1 mm of the entire thickness such that a conductor had a diameter of 2.25 mm, a first coating was formed by coating the high adhesion polyamideimide varnish having the polyamideimide resin containing MZA, a second coating was formed by coating the high flexibility polyamideimide varnish and a third coating was formed by coating the self-lubricating polyamideimide varnish.

At this time, the following Table 2 shows the polyamideimide varnish and the thickness of each coating used in the examples 1 to 9 and comparative examples 1 to 2.

TABLE 2

| | First coating | | Second coating | | Third coating | |
|---|---|---|---|---|---|---|
| Classification | Type | Thickness (mm) | Type | Thickness (mm) | Type | Thickness (mm) |
| Example 1 | Synthesis | 0.04545 | Synthesis | 0.04545 | Synthesis | 0.00909 |
| | example 1 | | example 2-1 | | example 3 | |
| Example 2 | Synthesis | 0.04545 | Synthesis | 0.04545 | Synthesis | 0.00909 |
| | example 1 | | example 2-2 | | example 3 | |
| Example 3 | Synthesis | 0.04545 | Synthesis | 0.04545 | Synthesis | 0.00909 |
| | example 1 | | example 2-3 | | example 3 | |
| Example 4 | Synthesis | 0.04545 | Synthesis | 0.04545 | Synthesis | 0.00909 |
| | example 1 | | example 2-4 | | example 3 | |
| Example 5 | Synthesis | 0.04545 | Synthesis | 0.04545 | Synthesis | 0.00909 |
| | example 1 | | example 2-5 | | example 3 | |
| Comparative | Synthesis | 0.04545 | Synthesis | 0.04545 | Synthesis | 0.00909 |
| example 1 | example 1 | | example 2-6 | | example 3 | |
| Example 6 | Synthesis | 0.08182 | Synthesis | 0.00909 | Synthesis | 0.00909 |
| | example 1 | | example 2-3 | | example 3 | |
| Example 7 | Synthesis | 0.06364 | Synthesis | 0.02727 | Synthesis | 0.00909 |
| | example 1 | | example 2-3 | | example 3 | |
| Example 8 | Synthesis | 0.02727 | Synthesis | 0.06364 | Synthesis | 0.00909 |
| | example 1 | | example 2-3 | | example 3 | |
| Example 9 | Synthesis | 0.00909 | Synthesis | 0.08182 | Synthesis | 0.00909 |
| | example 1 | | example 2-3 | | example 3 | |
| Comparative | Synthesis | 0.04545 | Synthesis | 0.04545 | Synthesis | 0.00909 |
| example 2 | example 1 | | example 4 | | example 3 | |

The following Table 3 shows test results for pin hole, crack, adherence, wear resistance in one direction, breakdown, resistance to softening, thermal shock resistance and static friction of the insulated electric wires manufactured using the above examples 1 to 9 and comparative example 1 or 2.

The test for each characteristic shown in the following Table 3 was made according to KSC 3106.

TABLE 3

| | | | | | | | | | | | Comparative | |
|---|---|---|---|---|---|---|---|---|---|---|---|---|
| | | Examples | | | | | | | | | examples | |
| Classification | | 1 | 2 | 3 | 4 | 5 | 6 | 7 | 8 | 9 | 1 | 2 |
| Pin hole | 3EA | 0 | 0 | 0 | 0 | 0 | 0 | 0 | 0 | 0 | 0 | 0 |
| Crack | 1 D | 0 | 0 | 0 | 0 | 0 | 0 | 0 | 0 | 0 | 0 | 0 |
| | wrapping | | | | | | | | | | | |
| | NEMA | 1/30 | 0/30 | 0/30 | 0/30 | 0/30 | 0/30 | 0/30 | 0/30 | 0/30 | 2/30 | 2/30 |
| | 20% | | | | | | | | | | | |
| | elongation | | | | | | | | | | | |
| | 1 d~3 d | | | | | | | | | | | |
| Adher- | Cutting | ◯ | ◯ | ◯ | ◯ | ◯ | ◯ | ◯ | ◯ | ◯ | ◯ | ◯ |
| ence | | | | | | | | | | | | |
| Wear | 1500 g | 1950 | 1900 | 1900 | 1890 | 1700 | 1950 | 1900 | 1900 | 1350 | 1300 | 1650 |
| resist- | load (gf) | | | | | | | | | | | |
| ance | | | | | | | | | | | | |
| in one | | | | | | | | | | | | |
| direc- | | | | | | | | | | | | |
| tion | | | | | | | | | | | | |
| Break- | 4150 V | 11000 | 11500 | 11500 | 12000 | 1200 | 12500 | 10500 | 12000 | 12000 | 12000 | 12000 |
| down | | | | | | | | | | | | |
| Resist- | 300° C. | 395 | 385 | 380 | 380 | 380 | 320 | 360 | 390 | 395 | 350 | 360 |
| ance to | | | | | | | | | | | | |
| soften- | | | | | | | | | | | | |
| ing | | | | | | | | | | | | |
| Thermal | 240° C./ | 0/30 | 0/30 | 0/30 | 0/30 | 0/30 | 0/30 | 0/30 | 0/30 | 0/30 | 0/30 | 5/30 |
| shock | 1 h/1 D | | | | | | | | | | | |
| resist- | 240° C./ | 2/30 | 2/30 | 0/30 | 0/30 | 0/30 | 0/30 | 0/30 | 0/30 | 0/30 | 0/30 | 10/30 |
| ance | 0.5 h/3 d | | | | | | | | | | | |
| | after 20% | | | | | | | | | | | |
| | elongation | | | | | | | | | | | |

| | | | | | | | | | | | |
|---|---|---|---|---|---|---|---|---|---|---|---|
| Static friction | 0.05 | 0.05 | 0.05 | 0.05 | 0.05 | 0.05 | 0.05 | 0.05 | 0.05 | 0.05 | 0.05 |

As shown in the above Table 3, the examples 1 to 9 according to the present invention used a high adhesion polyamideimide resin to increase flexibility, and thus it was found that few crack was detected and adherence with a conductor was excellent. And, the examples 1 to 9 formed a high flexibility polyamideimide resin on the high adhesion resin layer, and thus it was found that wear resistance, breakdown and resistance to softening were also excellent.

However, the comparative example 1 used an excessive amount of IPA, and thus it was found that flexibility was poor, and the comparative example 2 did not use the high flexibility polyamideimide resin, but a general polyamideimide resin as the second coating, and thus it was found that cracks were generated due to lack of flexibility.

As such, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

The present invention improves adherence between a polyamideimide resin and a conductor, and provides adhesive strength with the conductor to improve flexibility of an insulated electric wire and at the same time improve flexibility of an insulator without deterioration of heat resistance of the insulator.

What is claimed is:

1. An insulated electric wire, comprising:
a high adhesion resin layer configured to surround an outer surface of a conductor, and made of a polyamideimide resin containing a compound represented as the following Chemistry Figure 1 between imide groups in a polymer main chain; and
a high flexibility resin layer provided on the high adhesion resin layer, the high flexibility resin layer being manufactured by reacting an aromatic diisocyanate compound, an acid anhydride and a polybasic acid component, and made of a polyamideimide resin containing more content of the polybasic acid component than the acid anhydride, 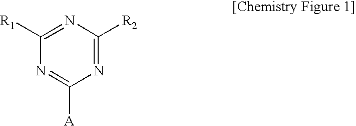
where each of R₁ and R₂ is independently any one of an imide group and an imide group-alkylene group, and at this time, the alkylene group is any one selected from methylene and ethylene, and
where A of the Chemistry Figure 1 is any one selected from 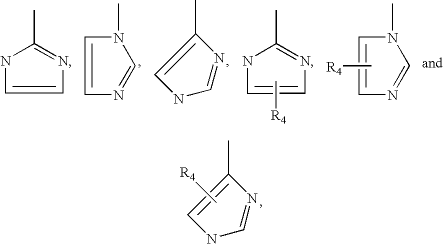
and at this time, R₄ represented in chemistry figure of a material selected as A is independently any one alkyl group selected from methyl and ethyl.

2. An insulated electric wire, comprising:
a high adhesion resin layer configured to surround an outer surface of a conductor, and made of a polyamideimide resin containing a compound represented as the following Chemistry Figure 2 between imide groups in a polymer main chain; and
a high flexibility resin layer provided on the high adhesion resin layer, the high flexibility resin layer being manufactured by reacting an aromatic diisocyanate compound, an acid anhydride and a polybasic acid component, and made of a polyamideimide resin containing more content of the polybasic acid component than the acid anhydride, 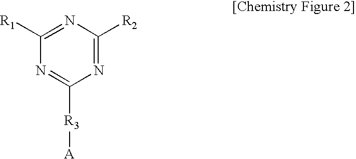
where each of R₁ and R₂ is independently any one of an imide group and an imide group-alkylene group, and at this time, the alkylene group is any one selected from methylene and ethylene,
where R₃ of the Chemistry Figure 2 is any one alkylene group selected from methylene, ethylene and propylene, and
where A is any one selected from 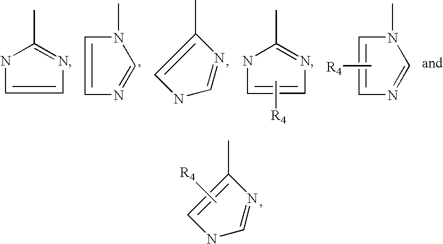
and at this time, R₄ represented in chemistry figure of a material selected as A is independently any one alkyl group selected from methyl and ethyl.

3. The insulated electric wire according to claim 1 or 2,
wherein R₄ is in the form of two R₄ bonded to an imidazole group.

4. The insulated electric wire according to claim 1 or 2,
wherein the compound of the Chemistry Figure 1 or 2 is contained with a mole ratio of 1:1 to 1:0.1 to mole of an imide chain of the polyamideimide resin of the high adhesion resin layer.

5. The insulated electric wire according to claim 1 or 2,
wherein the acid anhydride is any one selected from the group consisting of trimellitic anhydride (TMA), pyromellitic anhydride (PMDA), 3,4,3,4′-biphenyltetracarboxylic anhydride (BPDA), 3,4,3′,4′-benzophenonetetracarboxylic anhydride (BTDA) and 3,4,3′,4′-diphenylsufonetetracarboxylic anhydride (DSDA), or their mixtures.

6. The insulated electric wire according to claim 1 or 2,
wherein the polybasic acid component has a polybasic functional group at meta or ortho position of an aromatic ring.

7. The insulated electric wire according to claim 1 or 2,
wherein the polybasic acid component is any one selected from the group consisting of isophthalic acid, orthophthalic acid, benzophenone, dicarboxylic acid, 3,4′-diphenylmethanedicarboxylic acid, 3,3′-diphenylmethanedicarboxylic acid, 3,4′-diphenyletherdicarboxylic acid, 3,3′-diphenyletherdicarboxylic acid, 3,4′-diphenylsulfonedicarboxylic acid, 3,3′-diphenylsulfonedicarboxylic acid, adipic acid, sebacic acid and dodecane dicarboxylic acid, or their mixtures.

8. The insulated electric wire according to claim 1 or 2,
wherein the polybasic acid component is contained with 5 to 80 mol % of the entire polybasic acid or polybasic acid anhydride.

9. The insulated electric wire according to claim 1 or 2,
wherein the high flexibility resin layer is made of the polyamideimide resin that is reacted with mole ratios of 0.3 to 1.0 mol of the acid anhydride and 0.05 to 0.08 mol of the polybasic acid component based on 1 mol of the diisocyanate compound.

10. The insulated electric wire according to 1 or 2, further comprising:
a self-lubricating polyamideimide resin layer provided on the high flexibility resin layer.

11. The insulated electric wire according to claim 10,
wherein the high adhesion resin layer, the high flexibility resin layer and the self-lubricating resin layer has a thickness ratio of 1 to 9:9 to 1:1.
